(19) United States
(12) Patent Application Publication
(10) Pub. No.: US 2004/0203631 A1
(43) Pub. Date: Oct. 14, 2004

(54) Method and system for providing variable frequency patterns for vibration of a wireless device

(76) Inventors: John Patrick Wong, Vancouver (CA); Randy Chang, Vancouver (CA)

Correspondence Address: SCHEEF & STONE, L.L.P., 5956 SHERRY LANE, SUITE 1400, DALLAS, TX, 75225, US

(21) Appl. No.: 10/108,725

(22) Filed: Mar. 28, 2002

(51) Int. Cl. H04M 3/42

(52) U.S. Cl. 455/414.1; 455/415

(57) ABSTRACT

A method for providing variable frequency patterns for vibration of a wireless device is provided. The method includes receiving a call at the wireless device, the call associated with a caller identifier. Frequency pattern data stored in the wireless device is searched for the caller identifier. A specified frequency pattern is retrieved from the frequency pattern data when the caller identifier is found in the frequency pattern data. The specified frequency pattern is associated with the caller identifier in the frequency pattern data. The specified frequency pattern is provided to a vibrator for the wireless device.

### TECHNICAL FIELD OF THE INVENTION

The present invention relates generally to communication systems and, more particularly, to a method and system for providing variable frequency patterns for vibration of a wireless device.

### BACKGROUND OF THE INVENTION

Many types of communication systems have been developed and implemented to effectuate communication of data between two or more sending and receiving stations. In some communication systems, the communication channel interconnecting the sending and receiving stations is formed of a radio channel defined upon a portion of the electromagnetic spectrum. A communication system utilizing radio channels is referred to as a radio communication system.

A cellular communication system is a type of radio communication system which has achieved wide levels of usage and has been installed throughout large geographical areas of the world. Advancements in communication technologies have permitted the development of successive generations of cellular communication systems.

Customization of ringing sounds, or ring tunes, has become popular for users of cellular and other mobile telephones due to the ease of changing the ring tune and the desire for individualization. In addition, users are able to assign ring tunes to particular callers such that the telephone rings with the assigned ring tune to identify an incoming call from the corresponding caller.

However, when a telephone is set to vibrate, the user has no way to change the vibration of the telephone. The user also has no way to identify who is calling him based on an individualized vibration, as with an individualized ring tune.

### SUMMARY OF THE INVENTION

In accordance with the present invention, a method and system for vibrating a wireless device using variable frequency patterns are provided that substantially eliminate or reduce disadvantages and problems associated with conventional systems and methods. In particular, a user of the wireless device is able to store one or more frequency patterns in the wireless device for use in vibrating the wireless device using different frequency patterns.

According to one embodiment of the present invention, a method for providing variable frequency patterns for vibration of a wireless device is provided. The method includes receiving a call at the wireless device, the call associated with a caller identifier. Frequency pattern data stored in the wireless device is searched for the caller identifier. A specified frequency pattern is retrieved from the frequency pattern data when the caller identifier is found in the frequency pattern data. The specified frequency pattern is associated with the caller identifier in the frequency pattern data. The specified frequency pattern is provided to a vibrator for the wireless device.

According to another embodiment of the present invention, a wireless device that is operable to vibrate using variable frequency patterns is provided that includes a frequency pattern database, a frequency pattern manager, and a vibrator. The frequency pattern database is operable to store a plurality of frequency patterns. The frequency pattern manager is coupled to the frequency pattern database. The frequency pattern manager is operable to store frequency patterns in the frequency pattern database and to retrieve frequency patterns from the frequency pattern database. The vibrator is coupled to the frequency pattern manager. The vibrator is operable to vibrate the wireless device based on a frequency pattern retrieved by the frequency pattern manager and provided to the vibrator.

Technical advantages of one or more embodiments of the present invention include providing a method for vibrating a wireless device using variable frequency patterns. In a particular embodiment, a user of the wireless device may customize the vibration for the wireless device with a particular frequency pattern that is stored in the wireless device. In another particular embodiment, the user of the wireless device may store frequency patterns that are associated with particular callers and/or groups of callers. As a result, the user may identify a caller, or a group to which the caller belongs, that is attempting to call the wireless device based on the frequency pattern with which the wireless device vibrates when the incoming call is received.

Other technical advantages will be readily apparent to one skilled in the art from the following figures, description, and claims.

### BRIEF DESCRIPTION OF THE DRAWINGS

For a more complete understanding of the present invention and its advantages, reference is now made to the following description taken in conjunction with the accompanying drawings, wherein like reference numerals represent like parts, in which:

FIG. 1 is a block diagram illustrating a communication system comprising a wireless device operable to vibrate using variable frequency patterns in accordance with one embodiment of the present invention;

FIGS. 2A-C are tables illustrating data that may be stored in one of the wireless devices of FIG. 1 to provide variable frequency patterns for vibration of the wireless device in accordance with one embodiment of the present invention; and

FIG. 3 is a flow diagram illustrating a method for vibrating one of the wireless devices of FIG. 1 using variable frequency patterns in accordance with one embodiment of the present invention.

### DETAILED DESCRIPTION OF THE DRAWINGS

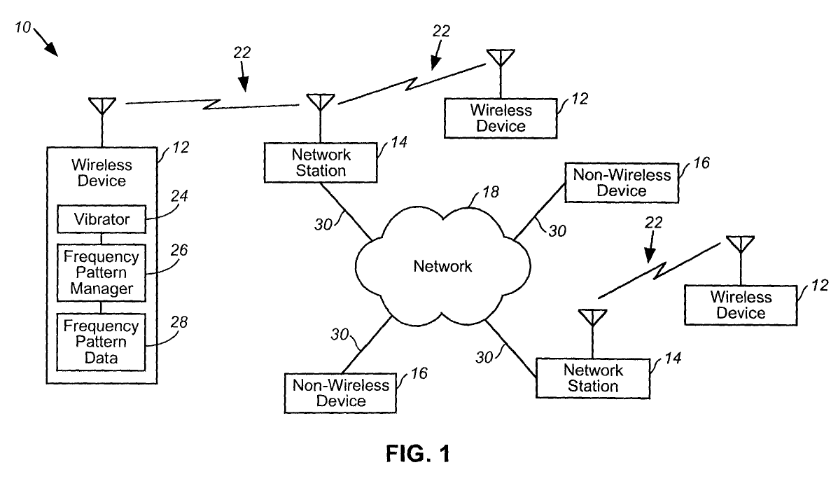

FIG. 1 is a block diagram illustrating a communication system 10 comprising at least one wireless device that is operable to vibrate using variable frequency patterns in accordance with one embodiment of the present invention. The communication system 10 comprises a plurality of wireless devices 12, a plurality of network stations 14 for providing communication for wireless devices 12 located in specified geographical areas, a plurality of non-wireless devices 16, and a network 18 for providing communication for the network stations 14 and non-wireless devices 16. It will be understood that the system 10 may comprise additional components of a communication system, such as any suitable servers coupled to the network 18 or any other suitable components (not shown in FIG. 1).

Each wireless device 12 may comprise a cellular or other mobile telephone, a pager, or other suitable device capable of communicating with a network station 14. As used herein, “each” means every one of at least a subset of the identified items. Each wireless device 12 is operable to communicate with a network station 14 over a wireless interface 22. Thus, the wireless interface 22 is operable to transfer messages between a wireless device 12 and a network station 14. The wireless interface 22 may comprise communication channels defined upon radio links, such as an Enhanced Data for GSM (Global System for Mobile communications) Evolution interface, a Wideband Code Division Multiple Access interface, or any other suitable interface.

Each wireless device 12 comprises a vibrator 24 that is operable to cause the wireless device 12 to vibrate. Thus, the vibrator 24 may comprise any suitable components that are operable to vibrate such that the wireless device 12 vibrates in order to notify a user of the wireless device 12 of an incoming call or message.

The wireless device 12 also comprises a frequency pattern manager 26 and frequency pattern data 28. The frequency pattern manager 26 is operable to manage the frequency pattern data 28. Thus, as described in more detail below, the frequency pattern manager 26 is operable to store and update frequency patterns in the frequency pattern data 28 and to delete and retrieve frequency patterns from the frequency pattern data 28. The frequency pattern manager 26 is also operable to provide frequency patterns retrieved from the frequency pattern data 28 to the vibrator 24 such that the vibrator 24 causes the wireless device 12 to vibrate at in accordance with the retrieved frequency pattern.

The frequency pattern manager 26 may comprise logic encoded in media. The logic comprises functional instructions for carrying out program tasks. The media comprises computer disks or other computer-readable media, application-specific integrated circuits, field-programmable gate arrays, digital signal processors, other suitable specific or general purpose processors, transmission media or other suitable media in which logic may be encoded and utilized.

The frequency pattern data 28 comprises a data store that is operable to store one or more frequency patterns for the wireless device 12, each of which may be used to cause the wireless device 12 to vibrate in a different manner from the other frequency patterns. Thus, for example, the frequency pattern data 28 may comprise a random access memory, a database or any other suitable data store.

Each network station 14 is operable to provide wireless devices 12 with access to voice and/or data networks by providing voice and/or data messages received from the wireless devices 12 to the network 18 and messages received from the network 18 to the wireless devices 12. According to one embodiment, the network stations 14 comprise base stations for a public land mobile network and the wireless devices 12 comprise mobile telephones and/or pagers.

In one embodiment, the network 18 comprises a packet-switched network, such as the Internet, or other suitable network. However, the network 18 may also comprise any interconnection found on any computer network such as a local area network (LAN), a wide area network (WAN), or any other communications and data exchange systems created by connecting two or more computers.

Each network station 14 and each non-wireless device 16 are operable to communicate with the network 18 over communication lines 30, which may be any type of communication link capable of supporting data transfer. In one embodiment, the communication lines 30 may comprise, alone or in combination, Integrated Services Digital Network (ISDN), Asymmetric Digital Subscriber Line (ADSL), T1 or T3 communication lines, hardwire lines, or telephone links. It will be understood that the communication lines 30 may comprise other suitable types of data communication links. The communication lines 30 may also connect to a plurality of intermediate servers between the network 18 and the network stations 14 and the non-wireless devices 16.

In operation according to one embodiment, a user of a wireless device 12 programs the frequency pattern data 28 through the frequency pattern manager 26 in order to customize the frequency pattern for vibration of the wireless device 12 and/or to assign different frequency patterns to specific individuals and/or groups of individuals from whom calls may be received at the wireless device 12.

After the information is stored in the frequency pattern data 28, when a subsequent call is received at the wireless device 12, the frequency pattern manager 26 retrieves the appropriate frequency pattern from the frequency pattern data 28 and provides the frequency pattern to the vibrator 24. The vibrator 24 then vibrates the wireless device 12 based on that frequency pattern.

In this way, the user of the wireless device 12 may customize the vibration for the wireless device 12 with a single frequency pattern or the user of the wireless device 12 may identify callers who are attempting to call the wireless device 12 based on the frequency pattern with which the wireless device 12 vibrates when the incoming call is received.

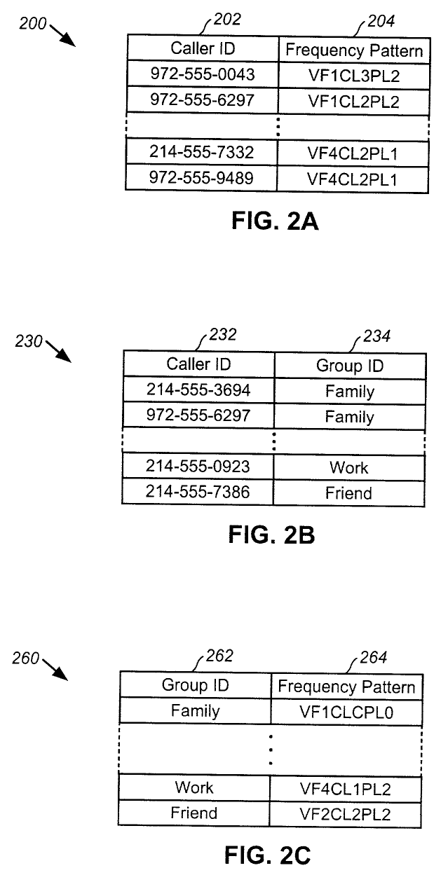

FIG. 2A illustrates an individual frequency pattern table 200 that is operable to store frequency patterns for a plurality of individual callers in the frequency pattern data 28 of a wireless device 12. According to one embodiment, the individual frequency pattern table 200 comprises one or more caller identifiers 202, each of which is operable to identify a particular caller, and a corresponding frequency pattern 204 for each caller identifier 202. It will be understood that the individual frequency pattern table 200 may comprise any other suitable information without departing from the scope of the present invention.

The caller identifiers 202 may be stored in any suitable format. For example, the caller identifiers 202 may comprise numerical values, such as telephone station identifiers, or any other suitable identifiers. According to one embodiment, some of the caller identifiers 202 may comprise a portion of a telephone station identifier, as opposed to a complete telephone station identifier. Thus, for example, if a business has a plurality of telephone lines such as 214-555-XXXX, a single frequency pattern 204 may be assigned to a caller identifier 202 of 214-555. Alternatively, a group identifier may be used as discussed below in connection with FIGS. 2B-C.

The frequency patterns 204 may also be stored in any suitable format. For example, the frequency patterns 204 may comprise alphanumerical values or any other suitable data. According to the illustrated embodiment, each frequency pattern 204 comprises an alphanumerical value that is operable to identify a vibration frequency by a vibration frequency identifier, a cycle length by a cycle length identifier, and a pause length by a pause length identifier. In an alternative embodiment in which the wireless device 12 vibrates without pausing, the frequency pattern 204 may comprise only a frequency identifier.

Thus, for example, the caller identifier 202 comprising 972-555-0043 has a corresponding frequency pattern 204 of VF1CL3PL2. For this embodiment, the frequency pattern 204 refers to a vibration frequency of “1,” a cycle length of “3,” and a pause length of “2.” Thus, when a party calls the wireless device 12 from a telephone, such as another wireless device 12 or a non-wireless device 16 that has a telephone station identifier of 972-555-0043, the wireless device 12 would vibrate with a frequency identified by “1” for an amount of time identified by “3” with a pause identified by “2,” before vibrating again for the amount of time identified by “3,” and so on in order to identify the calling party to the user of the wireless device 12.

For this embodiment, the frequency pattern data 28 is operable to store the frequency identifiers with corresponding frequencies, the cycle length identifiers with corresponding cycle lengths, and the pause length identifiers with corresponding pause lengths. Alternatively, the cycle length identifiers may comprise a number of time units, such as seconds, which correspond to the cycle length and the pause length identifiers may comprise a number of time units, such as seconds, which correspond to the pause length. In this embodiment, the frequency pattern data 28 may be operable to store only the frequency identifiers with corresponding frequencies.

FIG. 2B illustrates a group identifier table 230 that is operable to store group identifiers for a plurality of individual callers in the frequency pattern data 28 of a wireless device 12. FIG. 2C illustrates a group frequency pattern table 260 that is operable to store frequency patterns for each of the groups identified in the group identifier table 230 in the frequency pattern data 28 of the wireless device 12.

According to one embodiment, the group identifier table 230 comprises one or more caller identifiers 232, each of which is operable to identify a particular caller, and a corresponding group identifier 234 for each caller identifier 232. It will be understood that the group identifier table 230 may comprise any other suitable information without departing from the scope of the present invention. In addition, the group frequency pattern table 260 comprises one or more group identifiers 262, each of which corresponds to a particular group identified by the group identifiers 234 of the group identifier table 230, and a corresponding frequency pattern 264 for each group identifier 262. It will be understood that the group frequency pattern table 260 may comprise any other suitable information without departing from the scope of the present invention.

The caller identifiers 232 may be stored in any suitable format. For example, the caller identifiers 232 may comprise numerical values, such as telephone station identifiers, or any other suitable identifiers. Similarly, the group identifiers 234 and 262 may be stored in any suitable format. For example, the group identifiers 234 and 262 may comprise alphanumerical values or any other suitable data.

The frequency patterns 264 may also be stored in any suitable format. For example, the frequency patterns 264 may comprise alphanumerical values or any other suitable data. According to the illustrated embodiment, each frequency pattern 264 comprises an alphanumerical value that is operable to identify a vibration frequency by a vibration frequency identifier, a cycle length by a cycle length identifier, and a pause length by a pause length identifier, as described in more detail above in connection with FIG. 2A. In addition, as illustrated in FIG. 2C for the group identifier 262 of “FAMILY,” a frequency pattern 264 may comprise a cycle length of “C” for “continuous” and a pause length of “0” in order to cause the wireless device 12 to vibrate continuously at the frequency identified by the frequency identifier.

For the embodiment illustrated in FIGS. 2B-C, each of a plurality of callers identified by caller identifiers 232 may be associated with a particular group by the group identifier 234 in the group identifier table 230. The group may then be collectively assigned a frequency pattern 264 based on the same group identifier 262 in the group frequency pattern table 260.

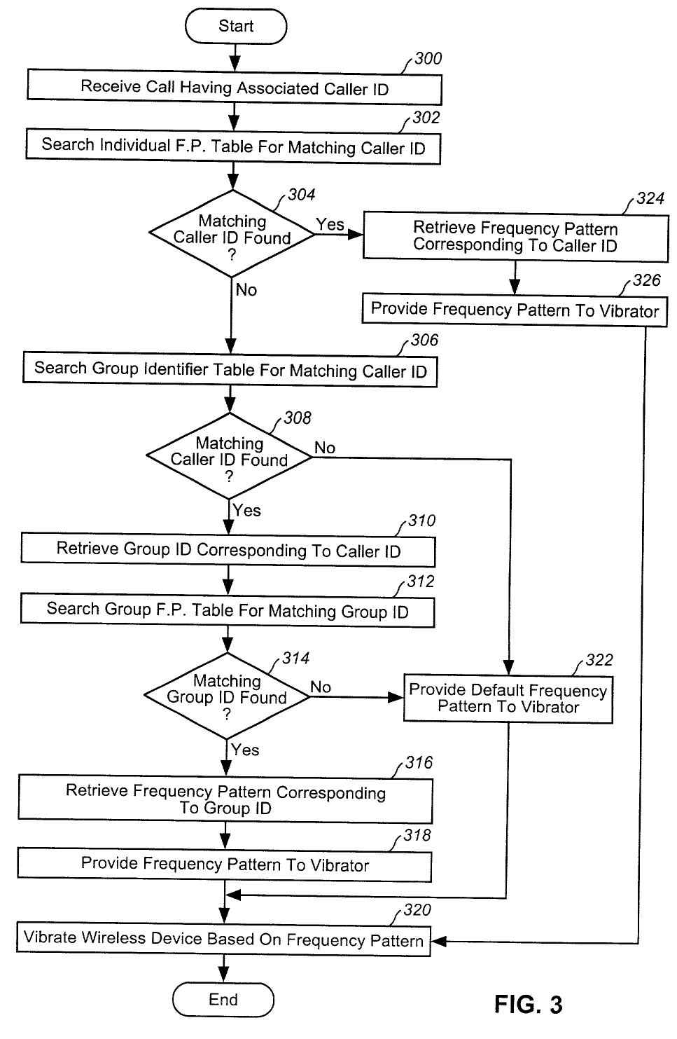

FIG. 3 is a flow diagram illustrating a method for vibrating a wireless device 12 using variable frequency patterns in accordance with one embodiment of the present invention. The method begins at step 300 where a call, such as a telephone call, a page or other suitable attempt to contact the wireless device 12, is received at the wireless device 12. The call is associated with a particular caller identifier, such as a telephone station identifier for a telephone used by the calling party to make the call.

At step 302, the frequency pattern manager 26 searches the individual frequency pattern table 200 in the frequency pattern data 28 for a caller identifier 202 matching the caller identifier associated with the call. At decisional step 304, a determination is made regarding whether or not a caller identifier 202 in the individual frequency pattern table 200 matches the caller identifier associated with the call.

If no match is found in the individual frequency pattern table 200, the method follows the No branch from decisional step 304 to step 306. At step 306, the frequency pattern manager 26 searches the group identifier table 230 in the frequency pattern data 28 for a caller identifier 232 matching the caller identifier associated with the call.

At decisional step 308, a determination is made regarding whether or not a caller identifier 232 in the group identifier table 230 matches the caller identifier associated with the call. If a match is found in the group identifier table 230, the method follows the Yes branch from decisional step 308 to step 310.

At step 310, the frequency pattern manager 26 retrieves the group identifier 234 corresponding to the caller identifier 232 from the group identifier table 230. At step 312, the frequency pattern manager 26 searches the group frequency pattern table 260 in the frequency pattern data 28 for the group identifier 262 corresponding to the group identifier 234.

At decisional step 314, a determination is made regarding whether or not a group identifier 262 in the group frequency pattern table 260 matches the group identifier 234 retrieved from the group identifier table 230. If a match is found in the group frequency pattern table 260, the method follows the Yes branch from decisional step 314 to step 316.

At step 316, the frequency pattern manager 26 retrieves the frequency pattern 264 corresponding to the group identifier 262. At step 318, the frequency pattern manager 26 provides the frequency pattern identified by the frequency pattern 264 to the vibrator 24. At step 320, the vibrator 24 vibrates the wireless device 12 based on the frequency pattern 264, at which point the method comes to an end.

Returning to decisional step 314, if no match is found in the group frequency pattern table 260, a frequency pattern has not been assigned to the group, and the method follows the No branch from decisional step 314 to step 322. At step 322, the frequency pattern manager 26 provides a default frequency pattern from the frequency pattern data 28 to the vibrator 24, after which the method continues to step 320 where the vibrator 24 vibrates the wireless device 12 based on the default frequency pattern.

Returning to decisional step 308, if no match is found in the group identifier table 230, the method follows the No branch from decisional step 308 to step 322 where the frequency pattern manager 26 provides the default frequency pattern from the frequency pattern data 28 to the vibrator 24.

Returning to decisional step 304, if a match is found in the individual frequency pattern table 200, the method follows the Yes branch from decisional step 304 to step 324. At step 324, the frequency pattern manager 26 retrieves the frequency pattern 204 corresponding to the caller identifier 202. At step 326, the frequency pattern manager 26 provides the frequency pattern identified by the frequency pattern 204 to the vibrator 24, after which the method continues to step 320 where the vibrator 24 vibrates the wireless device 12 based on the frequency pattern 204.

Although the present invention has been described with several embodiments, various changes and modifications may be suggested to one skilled in the art. It is intended that the present invention encompass such changes and modifications as fall within the scope of the appended claims.

What is claimed is:

1. A method for providing variable frequency patterns for vibration of a wireless device, comprising:
receiving a call at the wireless device, the call associated with a caller identifier;
searching frequency pattern data stored in the wireless device for the caller identifier;
retrieving a specified frequency pattern from the frequency pattern data when the caller identifier is found in the frequency pattern data, the specified frequency pattern associated with the caller identifier in the frequency pattern data; and
providing the specified frequency pattern to a vibrator for the wireless device.

2. The method of claim 1, further comprising vibrating the wireless device at the specified frequency pattern.

3. The method of claim 1, further comprising:
retrieving a default frequency pattern from the frequency pattern data when the caller identifier is not found in the frequency pattern data; and
providing the default frequency pattern to the vibrator for the wireless device.

4. The method of claim 3, further comprising vibrating the wireless device at the default frequency pattern.

5. The method of claim 1, further comprising:
storing a plurality of caller identifiers in the frequency pattern data; and
storing a frequency pattern associated with each caller identifier in the frequency pattern data.

6. The method of claim 1, searching frequency pattern data stored in the wireless device for the caller identifier comprising searching an individual frequency pattern table in the frequency pattern data for the caller identifier.

7. The method of claim 1, searching frequency pattern data stored in the wireless device for the caller identifier comprising searching a group identifier table in the frequency pattern data for the caller identifier and searching a group frequency pattern table for a group identifier associated with the caller identifier when the caller identifier is found in the group identifier table.

8. A system for providing variable frequency patterns for vibration of a wireless device, comprising:
a computer-processable medium; and
logic stored on the computer-processable medium, the logic operable to receive a call at the wireless device, the call associated with a caller identifier, to search frequency pattern data stored in the wireless device for the caller identifier, to retrieve a specified frequency pattern from the frequency pattern data when the caller identifier is found in the frequency pattern data, the specified frequency pattern associated with the caller identifier in the frequency pattern data, and to provide the specified frequency pattern to a vibrator for the wireless device.

9. The system of claim 8, the logic further operable to vibrate the wireless device at the specified frequency pattern.

10. The system of claim 8, the logic further operable to retrieve a default frequency pattern from the frequency pattern data when the caller identifier is not found in the frequency pattern data and to provide the default frequency pattern to the vibrator for the wireless device.

11. The system of claim 10, the logic further operable to vibrate the wireless device at the default frequency pattern.

12. The system of claim 8, the logic further operable to store a plurality of caller identifiers in the frequency pattern data and to store a frequency pattern associated with each caller identifier in the frequency pattern data.

13. The system of claim 8, the logic further operable to search frequency pattern data stored in the wireless device for the caller identifier by searching an individual frequency pattern table in the frequency pattern data for the caller identifier.

14. The system of claim 8, the logic further operable to search frequency pattern data stored in the wireless device for the caller identifier by searching a group identifier table in the frequency pattern data for the caller identifier and searching a group frequency pattern table for a group identifier associated with the caller identifier when the caller identifier is found in the group identifier table.

15. A wireless device operable to vibrate using variable frequency patterns, comprising:
a frequency pattern database operable to store a plurality of frequency patterns;
a frequency pattern manager coupled to the frequency pattern database, the frequency pattern manager operable to store frequency patterns in the frequency pattern database and to retrieve frequency patterns from the frequency pattern database; and
a vibrator coupled to the frequency pattern manager, the vibrator operable to vibrate the wireless device based on a frequency pattern retrieved by the frequency pattern manager and provided to the vibrator.

16. The system of claim 15, the frequency pattern database operable to store a caller identifier associated with each frequency pattern.

17. The system of claim 16, the frequency pattern manager further operable to search the frequency pattern database for one of the caller identifiers and to retrieve the frequency pattern associated with the caller identifier from the frequency pattern database when the caller identifier is found in the frequency pattern database.

18. The system of claim 17, the frequency pattern manage further operable to provide the frequency pattern associated with the caller identifier to the vibrator for the wireless device.

19. The system of claim 15, the frequency pattern database operable to store a plurality of caller identifiers, to store a group identifier associated with each frequency pattern and to associate a group identifier with each of at least a subset of the caller identifiers.

20. The system of claim 19, the frequency pattern manager further operable to search the frequency pattern database for one of the caller identifiers, to search the frequency pattern database for a group identifier associated with the caller identifier when the caller identifier is found in the frequency pattern database, to retrieve the frequency pattern associated with the group identifier when the group identifier is found in the frequency pattern database, and to provide the frequency pattern associated with the group identifier to the vibrator for the wireless device.
